(19) United States
(12) Patent Application Publication
(10) Pub. No.: US 2004/0064472 A1
(43) Pub. Date: Apr. 1, 2004

(54) Method and system for information management

(76) Inventors: Eugen H. Oetringer, Papendrecht (NL); Nigel Patrick Cresswell, Claygate (GB); Paulena McAnderson, Frisco, TX (US); David Sydney Robinson, Sandhurst (GB)

Correspondence Address: BAKER BOTTS L.L.P., 2001 ROSS AVENUE, SUITE 600, DALLAS, TX, 75201-2980, US

(21) Appl. No.: 10/260,122

(22) Filed: Sep. 27, 2002

(51) Int. Cl. G06F 17/00

(52) U.S. Cl. 707/102

(57) ABSTRACT

A method and system for information management are described. A document is stored in a central document repository. A community associated with the document is determined and the community is notified of the document. Feedback is received from the community based on the document and an updated document is generated based on the feedback. The updated document is approved based on an approval process. An incentive technique to be associated with the document is determined based on the document and the community and a decision process to be associated with the document is determined.

### RELATED APPLICATIONS

This application is related to co-pending U.S. application Ser. No. ______, filed Sep. 27, 2002 and entitled “Method and System for Maintaining Documents” (attorney docket 014208.1554).

### TECHNICAL FIELD OF THE INVENTION

This invention relates in general to data organization, and more particularly to a method and system for information management.

### BACKGROUND OF THE INVENTION

As computers have grown increasingly important in today's society, so has the amount of information exchanged by people using computers. Employees often use computers to communicate business-related information between themselves. As the amount of information has increased, companies may have difficulties creating, organizing and maintaining documentation. Also, employees may have difficulties finding relevant information and may ignore or not know of important company documents.

### SUMMARY OF THE INVENTION

According to the present invention, problems and disadvantages associated with previous techniques for information management may be reduced or eliminated.

According to one embodiment of the present invention, a method and system for information management are presented. A method and system for information management are described. A document is stored in a central document repository. A community associated with the document is determined and the community is notified of the document. Feedback is received from the community based on the document and an updated document is generated based on the feedback. The updated document is approved based on an approval process. An incentive technique to be associated with the document is determined based on the document and the community and a decision process to be associated with the document is determined.

The present invention may provide one or more technical advantages. Various embodiments of the present invention may provide some, all or none of these technical advantages. One such technical advantage is the capability to provide a centralized information system. The centralized information system supports increased availability of information to members of an organization, such as a business. Documents added to the central information system may be approved by members of a community and updated based on feedback received from the community. The approval process and the central information system may increase the trust level for documents in the central information repository. The increased trust may act as an incentive mechanism to encourage employees to use the central information system. Also, the time spent approving and updating the document may be balanced against the need to determine a final version of the document.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a block diagram illustrating a central document repository system according to one embodiment of the present invention;

FIG. 1A is an illustration of one embodiment of a graphical user interface associated with repository according to one embodiment of the present invention;

FIG. 2 is a chart illustrating details of one or more directives associated with the central document repository system according to one embodiment of the present invention;

FIG. 3 is a block diagram illustrating further details of one or more tiers associated with the central document repository system according to one embodiment of the present invention;

FIG. 4 is a flow chart illustrating the method of operation of the central document repository system according to one embodiment of the present invention;

FIG. 5 is a block diagram illustrating an information management system according to one embodiment of the present invention;

FIG. 6 is a flowchart illustrating a method for receiving feedback and approving documents according to one embodiment of the present invention;

FIGS. 6A-1 and 6A-2 are a table illustrating an example of how to select an approval workflow for a document associated with repository according to one embodiment of the present invention;

FIG. 7 is a flowchart illustrating a method for aging documents according to one embodiment of the present invention;

FIG. 8 is a table illustrating an example of information associated with the document according to one embodiment of the present invention; and

FIG. 9 is an illustration of one embodiment of a graphical user interface associated with the document repository associated with repository according to one embodiment of the present invention.

### DETAILED DESCRIPTION

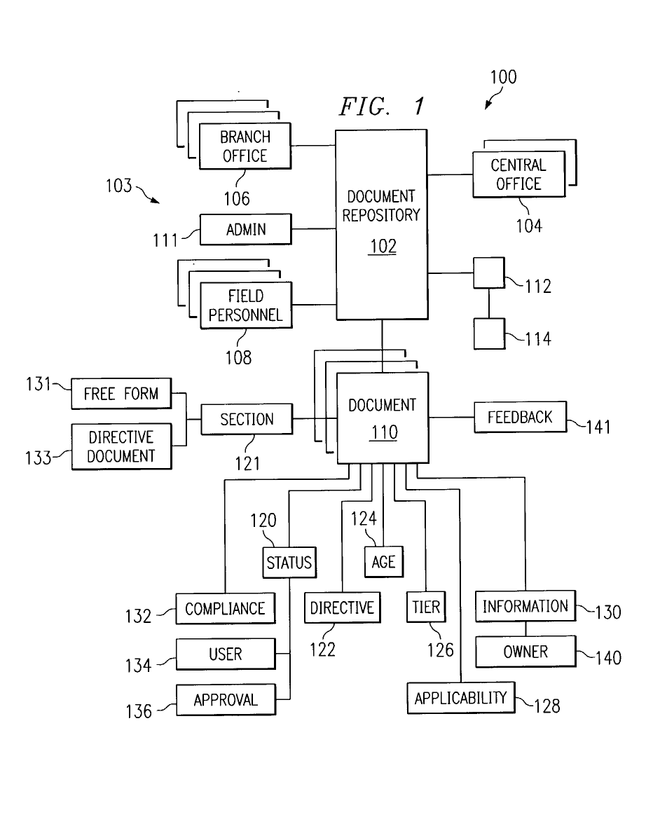

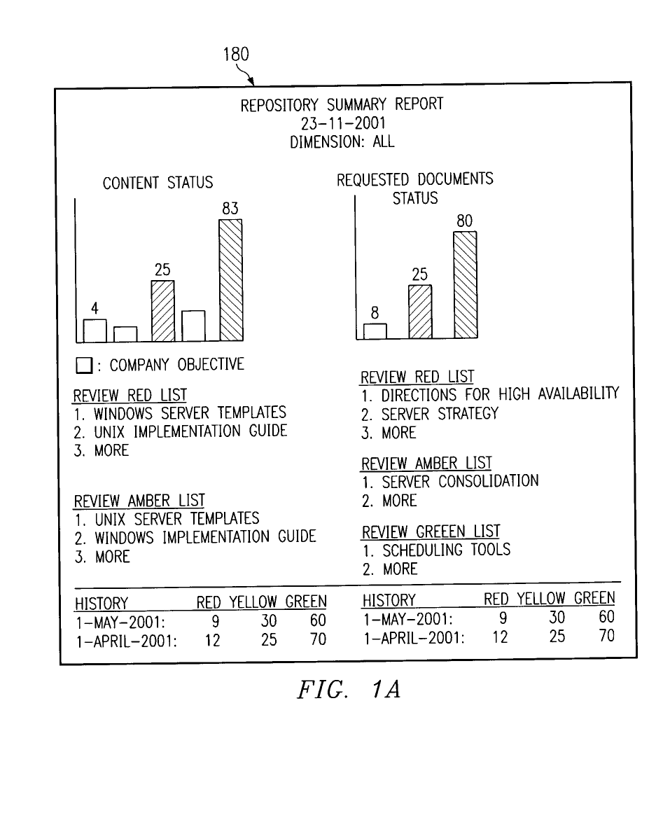

FIG. 1 is a block diagram illustrating a central document repository system 100. System 100 comprises a central document repository 102, an organization 103, one or more central offices 104, one or more branch offices 106 and one or more field personnel 108.

Document repository 102 comprises software operable to maintain, access and organize one or more documents 110 associated with organization 103. Document repository 102 may comprise software encoded on a computer readable medium and executable by a processor 112 and storable in storage 114. Processor 112 comprises a suitable electronic or other processing device operable to execute software and access storage 114. For example, processor 112 may comprise a general purpose central processing unit (CPU), an application-specific integrated circuit (ASIC), a microcontroller, and/or a field programmable gate array (FPGA). Storage 114 comprises a suitable combination of electronic, magnetic and/or optical storage devices operable to store data and information. For example, storage 114 may comprise a CD-ROM, a hard drive, random access memory (RAM), static RAM (SRAM) and/or read-only memory (ROM). In one embodiment, repository 102 is accessible via an intranet, extranet or the Internet, and information and documents 110 associated with repository 102 are displayed as world wide web pages.

Document repository 102 further has an associated administrator 111. Administrator 111 comprises a person and/or automated process responsible for maintaining document repository 102. Administrator 111 may be responsible for determining properties of document 110.

Organization 103 comprises a business, a non-profit organization, a governmental body or other suitable group having members and operable to use document repository 102. For example, organization 103 may comprise a multinational company.

Central office 104 comprises a headquarters or other primary location associated with a particular business, such as organization 103, with employees who may access and use repository 102. Depending on the organization of the business, the business may have multiple central offices with varying or different responsibilities. For example, a particular business may have a central office for legal affairs and a central office for executives. Central office 104 may be spread across multiple geographic locations while comprising a single logical entity. In general, central office 104 represents a primary or high level facility, such as a headquarters, for a particular business.

Branch office 106 comprises subordinate, satellite and/or non-primary locations associated with a particular business, such as organization 103, with employees who may access and use repository 102. For example, branch office 106 may comprise one or more of a manufacturing facility, a research facility, and/or a sales office. In general, branch office 106 may include minor or major facilities associated with a particular business.

Field personnel 108 comprise personnel associated with organization 103 who may be working at remote sites, with clients, or other similar duties that may take them outside of central office 104 and branch office 106 that may access and use repository 102. For example, field personnel 108 may include technical personnel working at a client's site under a particular contract.

While central office 104, branch office 106 and field personnel 108 have been described separately, various organizations 103 may be organized in various ways such that organization 103 does not have a central office, a branch office and/or field personnel. Such business may still use system 100. For example, a business may be spread across multiple physical locations which are each considered to be equally important or a business may have only a single location.

Documents 110 comprise documents and information associated with organization 103 for use by members of organization 103. For example, documents 110 may comprise standards documents for use in an enterprise, such as standards associated with information technology. In one embodiment, document 110 may further comprise software applications for use by members of organization 103. Each document 110 has a respective associated status 120, section 121, directive 122, aging 124, tier 126, applicability 128, general information 130, feedback 141 and compliance level 132. As used herein, each means each of at least a subset of the identified items.

Status 120 comprises one or more indications related to the status of document 110. Status 120 may be indicated relative to aging 124 of document 110. For example, status 120 may indicate the reliability of the document and whether the document has been approved.

In one embodiment, status 120 comprises a user status 134 and an approval status 136. User status 134 comprises one or more indications related to the status and reliability of document 110 as with respect members and groups of organization 103. For example, it may indicate the reliability of the document for a particular user community through the assignment of green, amber and red flags where green indicates that the document is reliable, amber indicates that the document is reliable, but should be used with caution, and red may indicate that the document is to be used with extreme care. Additional comments may then be provided to justify the amber and red statuses. Approval status 136 comprises one or more indications of whether document 110 has been approved. More specifically, approval status 136 indicates whether document 110 is a draft, pending approval or is approved. Approval status 136 may further indicate the approval status with respect to particular members and/or groups of organization 103. For example, approval status 136 may indicate “approved” by the United States geographic group and “draft” by the European geographic group.

Section 121 comprises an indication of the purpose and level of detail of document 110 and indicates one or more sections of repository 102 associated with document 110. In one embodiment, section 121 represents both sections and associated section headers. Sections 121 may comprise various categories used to indicate the scope, audience, subject and/or other categories of document 110. For example, sections 121 may include section headers such as information technology trends, best practices and architectures, and sections such as industry, technology, applications, security and infrastructure. In one embodiment, section 121 may further refine tiers 126 and directives 122. For example, a section entitled “applications” may refine a “global” tier of “policy” directive documents.

In one embodiment, section 121 indicates whether document 110 is a free-form document 131 or a directive document 133. Free-form document 131 comprises information not associated with a particular directive 122. Directive document 133 comprises information associated with one or more directives 122. For example, a directive document 122 may contain multiple strategies such as computer operating systems to use and hardware to use. A free form document 124 can, for example, be a user guide outlining how to use a program. In an organization, documents 110 may be generated which apply to varying and different groups of people. For example, an organization may generate documents indicating corporate-wide strategy and documents representing procedures for particular departments.

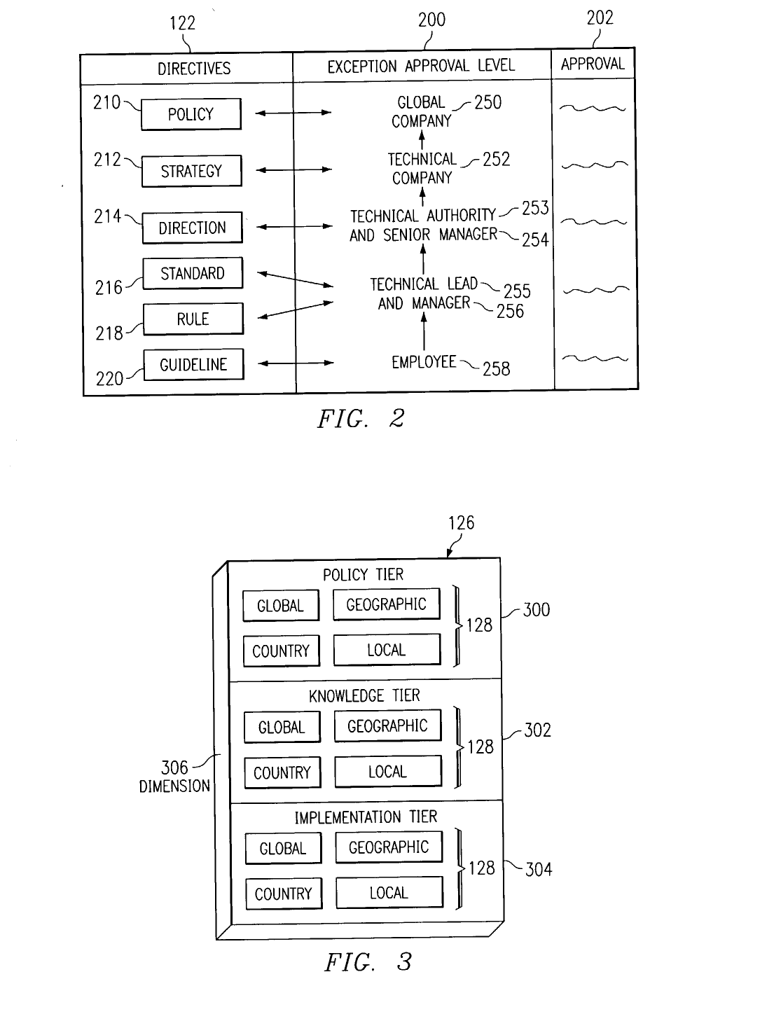

Directive 122 comprises an indication of the groups and/or members of organization 103 responsible for approving document 110. Multiple directives 122 may be associated with a single document 110. More specifically, document 110 may have different portions with different directives 122. Directive 122 further indicates the groups and/or members within organization 103 with authority to approve exceptions to compliance with document 110. Directives 122 are described in greater detail in association with FIG. 2.

Aging 124 is an indication of the age of document 110 and criteria for determining the reliability of document 110 based on the age of document 110. Aging 124 may comprise an absolute date, such as the date document 110 was approved or added to repository 102, or a relative date, such as the number of days since document 110 was last updated. In general, aging 124 comprises one or more items of suitable information related to the age of document 110 and suitable criteria for aging document 110 as appropriate to document 110. For example, aging 124 may be based on the date document 110 was approved or created, the date 110 was entered into document repository 102, and/or the date document 110 was last updated. In one embodiment, aging 124 may be used to automatically downgrade one or more status 120 items based on the aging criteria in aging 124.

Tier 126 comprises an indication of the applicability of document 110 with respect to the organizational structure of organization 103. In general, tier 126 indicates the breadth of applicability of document 110 across employees and departments of organization 103. Tier 126 is described in more detail in association with FIG. 3.

Applicability 128 comprises an indication of which portions of organization 103 document 110 applies and generally indicates the audience of document 110. For example, applicability 128 may comprise global applicability, country applicability and local applicability. Applicability 128 may also indicate particular industries, such as the computer operating system field of a particular country. Applicability 128 is described in more detail in association with FIG. 3.

General information 130 comprises additional information associated with document 110. For example, information 130 may comprise one or more of a title, a description, a version number, a product line, a confidentiality level, an importance and/or an owner 140 associated with document 110.

Owner 140 comprises an employee, a group or other member of organization 103 responsible for document 110. For example, owner 140 may comprise a network infrastructure group of a particular business.

Compliance 132 indicates whether compliance with document 110 is, for example, required or desired. Required compliance indicates that those impacted by document 110 are expected to comply with directives 122 in document 110 and that exceptions to compliance must be approved by the appropriate authority as indicated by directive 122. Desired compliance indicates that while compliance with document 110 is preferred, non-compliance does not require approval.

Feedback 141 comprises comments, suggestions and other feedback received from members and/or groups of organization 103 with respect to document 110. In one embodiment, feedback 141 comprises user feedback and owner feedback. The owner feedback comprises comments on document 110 by owner 140. The user feedback comprises comments from others than owner 140.

In one embodiment, feedback 141 may be categorized as approval feedback and user feedback. The approval feedback comprises feedback received during the approval process for document 110. The approval feedback may impact approval status 136. The user feedback comprises feedback received after approval of document 110. The user feedback may impact user status 134. In one embodiment, user feedback may also be provided for documents 110 having an approval status other than approved, such as draft or pending approval.

In operation, owner 140 or administrator 111 add document 110 to document repository 102. Administrator 111 or owner 140 may also group one or more documents into a document set. The document set comprises an indication that the documents 110 in the set are related in some way. In one embodiment, the document set comprises hypertext links between documents 110 in the document set.

In one embodiment, documents 110 may be organized such that each document 110 is separated into multiple documents fitting into a particular tier 126 and a particular section 121 of repository 102. The separated documents are than grouped into a document set. For example, a document set might contain policy, guideline and implementation documents with various levels of details and differing audiences. For example, a member of organization 103 may initially be interested in guideline documents while another member might be interested in policy documents only. The member can then view other documents in the same set as the guideline or policy documents.

Status 120 is then set to, for example, draft, pending approval, approved or unapproved based on whether document 110 has been previously approved by the appropriate authority. More specifically, in one embodiment, user status 134 and approval status 136 are updated and represents multiple items of status information. Approval status 136 may comprise indicators of the progress toward approval of document 110 by particular groups in organization 103, such as geographic regions and/or project teams. For example, approval status 136 may indicate whether document 110 has been reviewed, has been approved by 25% or 50% of the groups required to approve document 110, and/or the highest authority level which has approved document 110. User status 134 items may indicate the reliability of document 110 independent of the approval status for document 110 for particular groups in organization 103. For example, user status 134 may indicate that the document is obsolete and/or inappropriate for the particular group, such as a global strategy document using a technology which is not available in a particular country. In general, as documents 110 may follow different approval processes and have different levels of reliability and applicability depending on the particular group, geographic region or other portion of organization 103, status 120 may include one or more indicators reflecting this information.

Section 121, directive 122, tier 126, and applicability 128 may then be determined for document 110. Section 121, directive 122, tier 126, applicability 128 and compliance 132 together indicate what kind of data document 110 involves, who approves exceptions to compliance with document 110 and where document 110 should be applied. In one embodiment, administrator 111 may determine section 121, directive 122, tier 126, compliance 132 and applicability 128 for document 110 and initiate approval of document 110. Alternatively, owner 140, other employees, and/or administrator 111 may determine section 121, directive 122, tier 126, compliance 132 and applicability 128 for document 110 and initiate the approval process. For example, if document 110 is a document that was developed by a project team for a specific purpose, document 110 might be useful to other portions of organization 103. Document 110 may then be added to the repository and approved by an authority. The authority judges whether indeed document 110 provides value, is in line with other directives 122, and makes other suitable determinations with respect to approving document 110. Administrator 111 may also consult with relevant technical personnel regarding how to set directive 112, tier 126 and repository section 135 to acquire information not known by administrator 111 and update approval status 136 of document 110 on behalf of the approval authority.

Aging 124 for document 110 is then determined. In one embodiment, default aging criteria for the aging criteria portion of aging 124 are determined by members of organization 103 who are knowledgeable regarding the subject matter for each section 121 and the default criteria is automatically assigned to each document 110 as document 110 is added to repository 102. In general, aging 124 may indicate different levels of reliability based on the particular document 110.

In one embodiment, aging 124 is set in order to assist in determining the reliability of document 110 and to trigger corrective action. For example, a document 110 containing a software directive may need updating every year as software vendors release new software versions about ones a year. The use of a warning indicator after 9 months and a ‘corrective action by owner required/use with extreme care’ indicator after another 3 months would be indicated by aging 124. In contrast, a document containing an evaluation for a particular hardware product might still be relevant after 4 years as this product may still be in production somewhere and aging 124 may indicate that a warning indicator might be appropriate and after another year an indicator of ‘use with extreme care’ may be used. Once an aging threshold has passed, document owners are expected to start corrective action. This can lead to a confirmation that document 110 is still reliable and to an extension of the aging period. Alternatively, it can lead into the replacement of document 110 by a new version, the removal of the document from the repository or a move of document 110 into an archive.

Other information 130 is also determined as appropriate for document 110. For example, document 110 may be considered to be confidential and may include a title and a description.

Compliance level 132 is then determined for document 110. Administrator 111, owner 140 and/or another suitable authority, such as that indicated in association with directive 122, may determine compliance level 132. For example, a country-wide standard for a particular organization 103 indicating approved equipment vendors may have a compliance level 132 of required. In general, compliance level 132 may be determined using suitable criteria based on document 110, directive 122, tier 126, applicability 128 and/or other suitable criteria information.

Documents 110 in repository 102 may next be approved using a suitable process or criteria. Status 120 may be updated from unapproved to approved by administrator 111 or the highest approval authority for document 110 once document 110 is approved.

Repository 102 may further operate to automatically age documents 110. More specifically, repository 102 may periodically examine one or more documents 110 to determine whether document 110 is becoming too old to be reliable based on aging 124 and the aging criteria stored with aging 124. For example, repository 102 may contain various criteria usable to determine whether a document 110 is becoming unreliable based on aging 124. If repository 102 determines that document 110 is becoming unreliable, then a notification may be sent to owner 140 indicating that document 110 is becoming too old and request that corrective action be taken. Repository 102 may also update status 120 to indicate that document 110 has become unreliable.

In one embodiment, repository 102 may also store one or more enhancement requests for missing information and/or documents. More specifically, members of organization 103 may identify information not present in repository 102 and request that such information be added. The requests for the missing information may then be seen by other members of organization 102 and documents 110 with the missing information may then be added to repository 102. For example, members of organization 103 may identify gaps in the knowledge contained in repository 102, or may request that information be added or changed in existing documents 110.

Often, once a document has been approved by a business, it is difficult to communicate later discovered problems with the document because there is no central location for company information. By indicating missing or incorrect data through the enhancement requests and updating status 120, problems with existing documents 110 and missing information may be identified and the erroneous document identified at the central repository 102.

Once document 110 is added to repository 102, members of organization may search repository 102 for desired documents 110. Searches may be performed on one or more of status 120, directive 122, aging 124, tier 126, applicability 128, information 130, compliance level 132, owner 140, the content of document 110, and other suitable information associated with document 110. For example, members of branch office 106 may search for knowledge tier documents related to the Europe region regarding computer network infrastructure equipment reviews. For another example, central office 104 may search repository 102 for policy tier documents related to vendor alliance strategies for organization 103 globally.

FIG. 1A is an illustration of one embodiment of a graphical user interface (GUI) 180 associated with repository 102. GUI 180 illustrates a summary report associated with repository 102. The summary report may be used, for example, by a higher level manager to determine the status of repository 102 and initiate actions to increase reliability of repository 102. The summary report may be generated based on, for example, status 120 and the number of red, amber and green status indications in status 120. The summary report may also configurably show historical information, such as the number of red, amber and/or green documents on a given date in the past. The manager may identify red reliability documents in the manager's area of responsibility and instruct owner 140 to update document 110 to remove the red status indication. For example, the manager may select “directions for high availability” in order to view that document and determine owner 140. In general, the summary report may be configured to display appropriate information for the manager or other user of the summary report, and may include hypertext links to more detailed information related to information displayed in the summary report.

FIG. 2 is a chart illustrating details of directives 122 according to one embodiment of the present invention. Table 1 illustrates an example of a document template for a document having one or more directives 122 and discusses the various portions of the document template for a “global strategy” document.

TABLE 1

| Part | Content | |
|---|---|---|
| 1. | The subject | |
| 2. | A very brief introduction into the subject; for | |
| | example business reason, ‘why’, industry | |
| | developments, and so forth | |
| 3. | A table (example included) against which | |
| | verification can be done plus an optional | |
| | exception table: | |
| | Global Strategy [or Policy or Policy Position | |
| | or Strategy or Strategy Position or Direction | |
| | or Direction Position or Knowledge-tier | |
| | Standard or Implementation-tier Standard or | |
| | Knowledge-tier Guideline or Implementation-tier | |
| | Guideline or Rule] | |
| | Element: | Windows ™ Operating System |
| | Current Status: | Windows98 ™ is generally |
| | | installed |
| | Avoid: | Versions that are older |
| | | than Windows98 ™ |
| | Use: | Time table A1 in appendix |
| | | A for implementation |
| | Emerging: | Windows ™ xyz in 2003 |
| | Exceptions: | |

| | |
|---|---|
| | Description |
| | 1. |
| | [List exceptions here; e.g. element ‘xyz’ does not |
| | yet apply in Europe] |
| 4. | Background Information |
| | This section contains highly concentrated |
| | background information such that the colleague, |
| | who might not be the top expert (but |
| | knowledgeable), can comfortably defend the |
| | directive in front of knowledgeable colleagues and |
| | management. |

Directives 122 may have an associated exception approval level 200 and approval authority 202. Exception approval level 200 indicates one or more members and/or groups with authority to approve exceptions to compliance with documents 110 having particular associated directives 122. Approval authority 202 indicates one or more members and/or groups of organization 103 which approve documents 110 with particular associated directives 122.

Directives 122 generally indicate the breadth of document 110. In one embodiment, directives 122 comprise a policy 210, a strategy 212, a direction 214, a standard 216, a rule 218 and a guideline 220. For example, applicability of policy 210, strategy 212, direction 214, standard 216, rule 218 and guideline 220 may be global or specific to geography, such as a global product line, geography product line, country product line or local product line.

In one embodiment, directive 122 may further include a directive position. The directive position includes instructions to prepare for a later release of an actual directive 122. For example, a strategy position may prohibit further ordering of a particular software because of the introduction of a new technology that makes the software obsolete.

Policy 210 comprises an instruction of the highest importance and far reaching impact. For example, policy 210 may include business function level instructions, such as an information technology policy 210 instructing organization 103 to build information technology infrastructure around a maximum of three operating systems. Policy 210 may require the highest level of approval and the highest level of approval for exceptions.

Positioned below policy 210, strategy 212 comprises an indication a document 110 of high importance and far reaching impact to organization 103. Strategy 212 documents include more detail than policy 210 documents, but less detail than direction 214 documents. In general, strategy 212 documents provide high level instructions requiring technical and managerial approval. For example, strategy 212 may specify the operating systems to be used in building an information technology infrastructure. More specifically, strategy 212 may define the use of operating systems a, b and c. As there might be insufficient support of operating system b in a specific country, a country may add a country specific strategy 212 which replaces operating system b with operating system d. Strategy 212 may have approval and exception authority at a level below policy 210, but above direction 214.

Direction 214 provides instructions that are technical in nature. For example, direction 214 may outline techniques for application availability, such as mirroring data to a second location in case of a major disaster at the primary site and indicate that mirroring is to be performed if the application needs to be up and running within two hours of the disaster. In general, the information provided by directions 214 may vary by industry and organization 103, as well as others. Directions 214 generally will be more specific than policies 210 and strategies 212. Directions 214 may be approved by a technical authority without the need for approval by a managerial authority. Similarly, approval for exceptions to directions 214 may be handled at a lower level than would be necessary for strategy 212.

Document 110 with directive 122 of standard 216 indicates a document that describes a standard or other reference document. For example, standard 216 may describe a file directory naming standard. A document 110 designated as a standard 216 is generally designed to be more specific than policy 210 or strategy 212.

Rule 218 may be similar to direction 214, but rule 218 is more relevant at the implementation stage while direction 214 is more relevant at the design and decision stage. Rules 218 and exceptions to rule 218 are approved at a lower level than for direction 214. For example, rule 218 may instruct an engineer to define dual path connectivity between a processor and a disk.

Guideline 220 represents an alternative to direction 214 and standard 216 with lower approval needs and lower approval needs for non-compliance.

As organization 103 increasingly uses directives 122 and repository 102, trust in the reliability and value of documents 110 and repository 102 may also increase. An increase in trust in repository 102 may cause more members of organization 103 to use repository 102 and increase the visibility and usability of knowledge within organization 103. For example, the descriptions of directives 122 provided to members of organization 103 may be detailed and specific to organization 103 so as to decrease uncertainty by members of organization 103 and increase the use of repository 102.

Directives 122 have an associated exception approval level 200. Exception approval level 200 may indicate one or more persons and/or groups in suitable combination with authority to approve exceptions to compliance with document 110. In one embodiment, policy 210 is associated with a global company approval level 250, strategy 212 is associated with a technical company approval level 252, direction 214 is associated with a technical authority approval level 253 and senior manager approval level 254, standard 216 and rule 218 are associated with technical lead approval level 255 and a manager approval level 256, and guideline 220 has an associated employee level 258. Depending on the size, organization and other factors associated with organization 103, different directives 122 and associated exception approval levels 200 may be used as appropriate. Groups indicated as exception approval levels 200 may, in one embodiment, also be responsible for approving documents 110. In one embodiment, approval of directives 122 may be done by a group that is one level higher in authority than the group which approves exceptions to directives 122.

Global company approval level 250 generally represents an extremely high level or the highest level management person or group responsible for handling and/or administering company-wide issues. For example, global company approval level 250 may represent an executive management committee.

Technical company approval level 252 generally indicates a senior technical leader. For example, technical company approval level 252 may indicate the highest level subject matter expert with broad knowledge of particular technologies.

Technical authority approval level 253 may represent a senior technical leader such as a project or department leader.

Senior manager approval level 254 may indicate a senior administrative manager such as a manager responsible for project or department budgets. In one embodiment, technical authority 253 and senior manager 254 may represent the same organizational level within organization 103, but with different spheres of responsibility. More specifically, the technical authority may be responsible for technical project management or technology issues while the senior manager is involved with personnel, budgetary and other administrative management issues. Depending on the organization, various breakdowns in responsibility may be used and the technical authority and senior manager may be combined in a single person or position.

Technical lead approval level 255 comprises a technical leader with preferably subject matter level expertise in multiple technology or process disciplines. In one embodiment, the technical leader is subordinate to the technical authority. For example, a technical lead may manage a small programming team. In another embodiment the technical leader may be recognized authority.

Manager approval level 256 represents middle management and lower-level management personnel responsible for the administrative side of projects or portions of projects, directive 122 execution or directive development. Typically, the manager is subordinate to the senior manager and may be generally equal in authority to the technical leader. The manager and technical leader may be combined in a single person or position.

Employee approval level 258 comprises the lowest level of the exception approval levels 200 and represents a suitable employee or a group of employees responsible for managing or executing particular guidelines 220.

A higher level of exception approval level 200 may approve exceptions to compliance delegated to lower level personnel. For example, the person or group represented by global company approval level 250 may approve exceptions to directives 122 while manager approval level 256 may only approve exceptions to the standards 216, rules 218, and guidelines 220. In general, exception approval levels 200 and directives 122 may be expanded or contracted in number and responsibility according to the particular circumstances of organization 103.

In one embodiment, approval of documents 110 is performed by the relevant entity. Within the repository, the chair and deputy chair represent the entity. The chair is responsible for ensuring necessary approval is obtained, such as additional management approval. If a formal entity representative is unavailable, a lead architect and deputy architect may approve content within their area of knowledge, and update repository 102 and status 120. To approve a document 110, the approval body may use particular guidelines, such as delegating approval to a project team, organization or individual, and determining whether a lower or higher level group should be involved to avoid conflicting decisions. In one embodiment, overall approval of, for example, a global directive 122 may require different groups to approve before it is finally approved. For example, technical groups in different geographies review and approve global directive 122 from the perspective of whether directive 122 is executable from technical perspectives in a particular geography. Based on the technical approval, management in each geography may review and approve from managerial aspects. A global technical group may review and approve from the global technical perspective. Based on this, a global management group may provide final approval.

In one embodiment, the exception approval level 200 may also be the body responsible for approving documents 110. Organizations 103 may also define various approval techniques for documents 110. For example, approval procedures may be based on whether compliance 132 is expected or desired, directive 122, tier 126, section 121 and the content of document 110.

In one embodiment, approval procedures comprise owner 140 submitting one or more documents 110 for approval and indicating in information 130 whether document 110 is public or restricted to approval bodies. Next, administrator 111 reviews document 110 with owner 140 for needed updates and to identify approval issues. Administrator 111 may then place one or more documents 110 into one or more approval sets based on the approval workflow for the individual documents 110. Administrator 111 then submits the approval set into an approval workflow. In one embodiment, lower-level groups in the workflow review and approve content while higher-level groups only review those directives 122 within the approval set that need to be approved by them. Alternatively, administrator 111 may submit all documents 110 into separate approval workflows. Once the highest level approval authority has approved documents 110, the documents 110 are made available in repository 102 and notification is sent to interested members of organization 103.

FIG. 3 is a block diagram illustrating further details of tier 126. In one embodiment, tier 126 comprises three tiers, a policy tier 300, a knowledge tier 302, and an implementation tier 304. Policy tier 300 comprises documents 110 related to highest level instructions, such as instructions to use only four different computer operating systems throughout organization 103. Preferred technology suppliers, and partnership information, such as company names and brief descriptions of the partnerships may also be stored in policy tier 300. In one embodiment, policy tier 300 comprises vision documents and top level policy documents. Summaries of knowledge tier 302 documents may also be included. In one embodiment, sufficient information may be provided to help employees, interested potential customers and industry advisors understand the reasoning behind a directive.

Knowledge tier 302 generally includes documents 110 issues related to providing direction and guidance at design and decision points, while also broadly relating to implementation. In one embodiment, concentrated knowledge for major areas within applicability 128, such as business models, service offerings, alliances, business trends and industry trends. Also, documents 110 in knowledge tier 302 may balance detail verse length to, for example, assist a member of organization 103, who is not a top-level expert, but defends strategies and service offerings in discussions with very knowledgeable customers. For example, knowledge tier 302 may comprise documents such as the following:

Business, industry, technology and process trend information; business model information and partnership information; service offering information; vendor and partner alliance information; infrastructure information, such as operating systems supported by organization 103, network facilities, enterprise management information, collaboration and messaging tool information, and world wide web information; application, security and process information; application engineering, communications, distributed systems, hosting and security capabilities; and reference architecture and best practices information.

Implementation tier 304 generally comprises documents 101 related to implementation details. Administrator 111 may consult with relevant technical personnel regarding how to set directive 112 tier 126 repository section 135 to acquire information not known by administrator 111. Knowledge tier 302 represents more focused information than that available in policy tier 300. For example, in a document repository 102 for information technology, policy tier 200 may contain a document with a policy describing the availability needs to different types of information technology applications of the company. Knowledge tier 302 may provide the technical directives and conceptual design re what type of technology to use for what type of availability needs.

Implementation tier 304 may contain the detailed instructions, for example an installation guide outlining how to install a particular computer system or user guide, instructing operators how to react for different kind of events. For example, implementation tier 304 may comprise directive documents 122 and free form documents 124 for areas such as user guides, implementation guides, evaluations, and process descriptions for the following areas:

Infrastructure, computer operating systems, network facilities, enterprise management, the world wide web, applications, security, processes, messaging and collaboration techniques; capabilities; reference solutions; and hardware and software.

Generally, tiers 126 may be broken down as appropriate for organization 103. More than three tiers may be used in particular embodiments based on the needs of organization 103.

In one embodiment, tier 126 further comprises a dimension 306. Dimension 306 comprises one or more product lines, industries and/or other categorizations of documents 110. Dimension 306 may be used to further refine applicability 128 based on product lines, marketing strategies and other categories appropriate for organization 103. For example, a technology company may have dimensions such as “global network infrastructure” and “European product marketing”.

FIG. 3 further illustrates details of applicability 128. Within each tier 126 documents 110 may be organized according to their applicability 128. By defining the audience for documents 110 using applicability 128 such as local, country, geographic and global, employees may more readily find desired documents 110. For example, answers to broad strategic questions are more likely to be answered by documents 110 in policy tier 300 than the highly detailed documents of implementation tier 304. Further, documents 110 related to the United States country applicability may not be as useful as documents designated for the country applicability of Brazil.

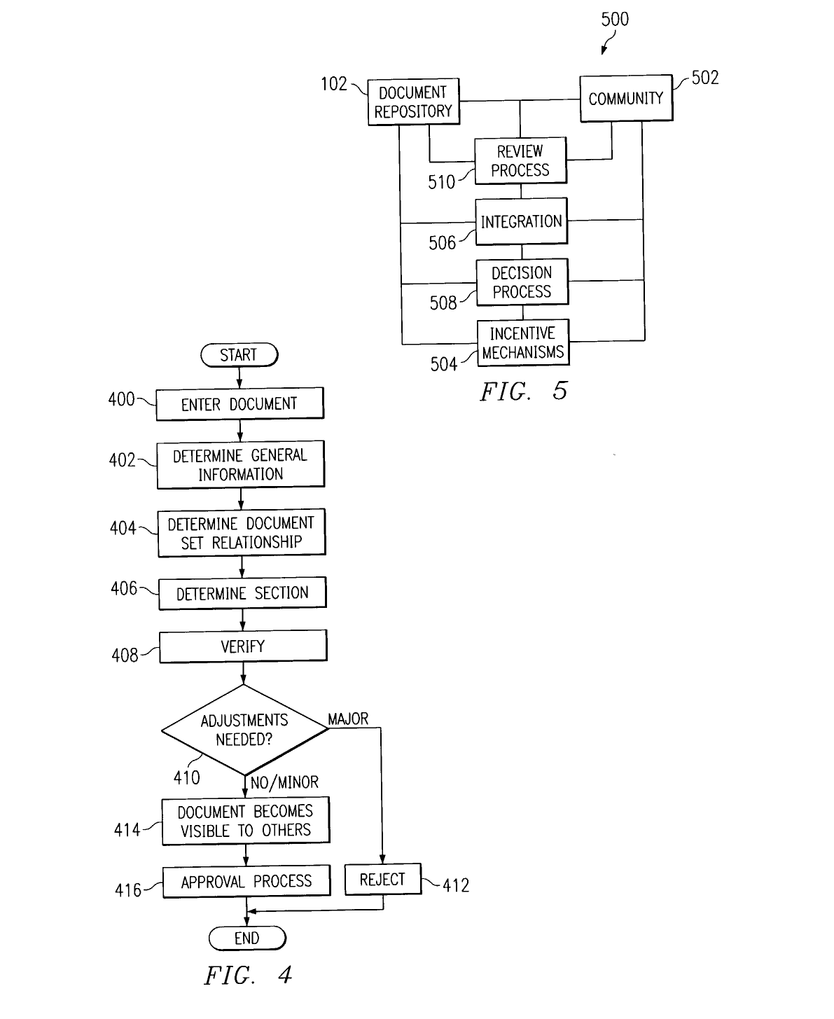

FIG. 4 is a flow chart illustrating the method of operation of repository 102 according to one embodiment of the present invention. The method begins at step 400, where a document 110 is entered into repository 102. More specifically, document 110 is physically added to repository 102, such as by adding a hypertext link in repository 102 to document 110 or by adding a copy of document 110 to repository 102. Document 110 may be added by owner 140 and/or administrator 111. In one embodiment, owner 140 has received information regarding the proper formatting of document 110 prior to document 110 being entered into repository 102.

Then, at step 402, information 130 is determined for document 110. For example, administrator 111 and/or owner 140 may apply various criteria, such as policies 210, to determine confidentiality and other general information 130 related to document 110.

Next, at step 404, one or more document sets are determined with respect to document 110, if any. For example, document 110 may be related to other, existing documents in repository 102. For another example, document 110 may be split up into multiple separate documents based on directives 122.

Proceeding to step 406, section 121 is determined for document 110 by owner 140 and/or administrator 111. For example, a document related to network management strategies may be in a “strategy-infrastructure” section 121.

Once section 121 is determined, various defaults may be applied by repository 102 based on section 121. For example, a particular section of the global tier and the standards directives may have associated default aging 124, confidentiality and other settings.

Next, at step 408, document 110 is verified by administrator 111. More specifically, administrator 111 verifies that steps 400, 402, 404 and 406 have been performed correctly and that the content of document 110 follows applicable guidelines. Then, at decisional step 410, administrator determines whether document 110 is to be adjusted and the extent of the adjustments. If the adjustments to document 110 are major then the MAJOR branch of decisional step 410 leads to step 412 where administrator 111 rejects document 110. At step 412, document 110 is removed from repository 102 and returned to owner 140 for adjustment. For example, a major adjustment may comprise significant rewriting of the content of document 110. If no adjustments are needed for document 110 or only minor adjustments are needed, then the NO/MINOR branch of decisional step 410 leads to step 414. The determination of minor versus major adjustments may vary based on organization 103, document 110 and other criteria as appropriate and may be determined using suitable techniques.

At step 414, administrator 111 allows members of organization 103 to view and access document 110. In one embodiment, document 110 may be visible to only portions of organization 103. Proceeding to step 416, document 110 is submitted for approval.

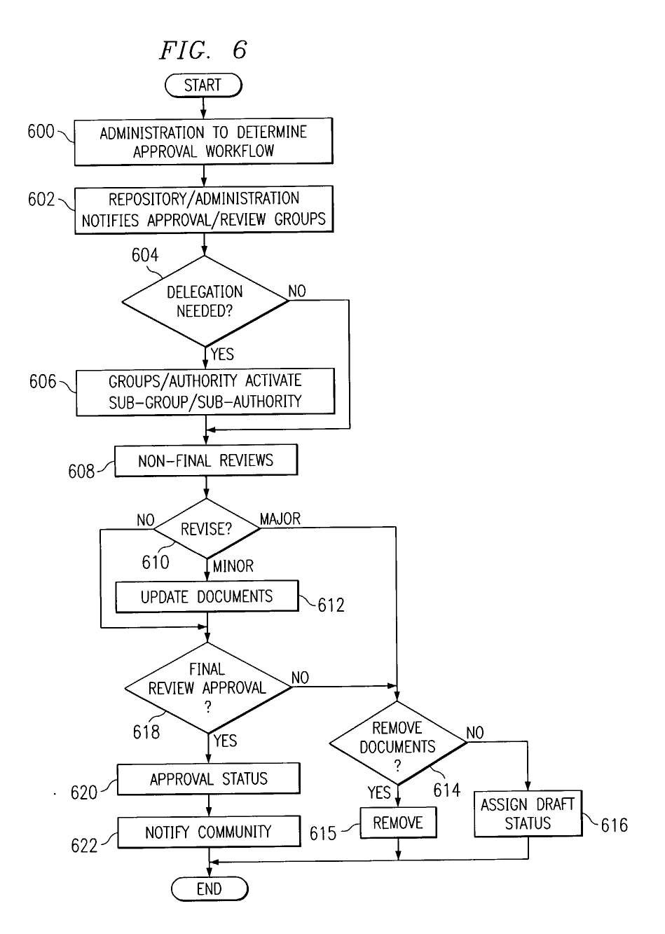

FIG. 5 is a block diagram illustrating an information management system 500 according to one embodiment of the present invention. In one embodiment, system 500 comprises a management technique for managing information technology information. Alternatively, other types of information and/or software may be managed using system 500. System 500 comprises the document repository 102, a community 502, one or more incentive mechanisms 504, integration 506, a decision process 508 and a review process 510.

Community 502 comprises one or more groups of people, who may or may not be members of organization 103, with expertise and/or interests related to organization 103. For example, community 502 may include various technical organizations when organization 103 is a technology company. The groups in community 502 may comprise users groups, standards bodies, technical personnel, industry forms and other suitable groups. For example, a database application developers group, a UNIX network security applications development group and/or a storage development users group may be parts of one or more communities 502.

Incentive mechanisms 504 comprise efforts and/or techniques for encouraging use of system 500 by members of organization 103. For example, incentive mechanism 504 may comprise monetary or social recognition of effective use of system 500. Further examples of incentive mechanisms may include quicker approval of a project, hardware or software if it is compliant with directives 122, providing background information justifying directive 122, reduced communications and selling efforts for owners 140 when the owner's document 110 is added to repository 102.

Integration 506 comprises using community 502 and incentive mechanisms 504 with respect to documents 110 in document repository 102. For example, proper integration may allow more effective use of documents 110 on company-wide and localized basis to increase trust in documents 110 and thus provide more effective use of information on an organization-wide basis.

Decision process 508 comprises balancing authoritarian decision making versus democratic decision making processes with respect to documents 110. For example, decision process 508 may balance the amount of input to be received from community 502 regarding a particular document 110 against the urgency of getting document 110 approved.

Review process 510 provides user feedback 140 with regards to the relevance of documents 110 for the represented user community. In one embodiment, authorized groups of community 502 may adjust the applicability or relevance of documents. For example, a geography level group may overrule a global directive 122 or parts thereof because of substantial issues with that directive with respect to the geography level group. User feedback is associated with document 110 in repository 102 and may impact user status 134.

Often, organizations 103 have difficulty distributing information to members of organization 103. The difficulty in distributing information often arises because different groups within organization 103 look to different people and places for information. For example, each project group within organization 103 may maintain a separate web page describing the status of that group's project. In addition, even when members of organization 103 know where to look for information within organization 103, the members may not know how current the available information is.

Document repository 102 provides a central location for information used by organization 103. Together, approval status 134, directive 122, tier 126 applicability 128 and user status 136 and feedback may be used to assist members of organization 103 with selecting documents from the central repository which are appropriate for those members and are current. For example, field personal 108 may be asked to provide technology guidance for a particular technology for a client and may use repository 102. Field personnel 108 may find related directives 122 to determine that the existing document is over one year old, has a warning indicator for aging 124 and a warning indicator for user status 129. Feedback 141 may include guidance regarding directive 122, such as adjustment needs or other value information reflecting the latest developments. Feedback 141 may prevent field personnel 108 from making an erroneous recommendation to the client.

Community 502 may be used to receive knowledgeable feedback regarding documents 110. Often, technical and other specialized knowledge is spread among a variety of people. These people may or may not be members of organization 103. One or more persons and groups with specialized knowledge may form community 502. Community 502 may be determined based on one or more factors. For example, the content of document 110 may indicate that particular groups are appropriate for inclusion in community 502.

Community 502 may be used to receive knowledgeable feedback regarding documents 110. Different communities 502 may be used based on the particular document 110 or, for example applicability 128. By presenting document 110 to community 502 for discussion, verification or approval organization 103 may benefit from increased accuracy and quality of document 110 through feedback from community 502. For example, a community 502 may comprise the members of a router development team, a network infrastructure team and a sales force in a technical organization 103 to discuss a document laying out the organization's strategy for network sales and consulting.

Incentive mechanisms 504 may be used to encourage use of repository 102, directives 122 and system 500. Incentive mechanisms 504 may encourage owner 140 and organization 103 to keep documents 110 and directives 122 current, connected to the needs of the users and fill gaps. By centralizing documents 110 in a single location, trust in documents 110 may be increased throughout organization 103. The increased reliability of documents 110 may also work as an incentive mechanism 504. Trust may be further increased as a subset of community 502. More specifically, user groups of document 110 provide user status 129 and user feedback information. Additional trust may be possible as community 502 sees follow-up, for example new versions of document 110, regarding issues raised from user status 129 and user feedback 140.

In one embodiment of system 500, day-to-day operations of system 500 and integration 506 may include the integration of system 500 with other business processes, procedures and sub-organizations of organization 103. For example, all processes, procedures and sub-organizations referencing or using IT technical documentation may reference repository 102 as the only source of information containing company instructions. Other or the same processes, procedures and sub-organizations may use system 500 to store and publish their documentation for use by same or other processes, procedures and sub-organizations. Further, incentive mechanisms 504 may be used to cause sub-organizations to integrate system 500 into their processes, procedures and day-to-day activities.

Integration 506 may include provisioning resources, such that community groups may generate feedback 141 as part of their normal work activities for inclusion in document 110. Community 502 may include numerous people and groups, however, each person and group may not have the same level of expertise or importance. For example, feedback 141 from an individual of community 502 may be reviewed, confirmed and prioritized by a technical leader, an authorized technical leader or an authorized group. Integration 506 may include balancing the amount of time to spend and cost on receiving feedback 140 and updating document 110 versus the amount of time to spend and cost if the approved document 110 encounters issues in parts of organization 103. Continuing the previous example, organization 102 may need to find the right balance of between extended review and approval processes to ensure document 110 is reliable versus business requirements to get a new document 110 approved and implemented as soon as possible.

Integration 506 may further include balancing incentive mechanisms 504 with respect to document 110 and community 502. For example, a monetary incentive mechanism may not be used in association with a large community 502 and a relatively unimportant document 110. In general, integration 506 involves balancing the needs of repository 102, community 502 and incentive mechanisms 504 to increase the reliability of documents 110 and compliance or implementation thereof.

Decision process 508 may include balancing authoritarian decision making processes with democratic decision making processes. For example, the approval process for a document 110 may vary depending on the urgency of the need for the document and the scope of coverage. A very urgent document may involve a decision process 508 for approval that is more authoritarian in order to allow faster approval. A document 110 with a global, organization-wide scope may have a relatively democratic decision process 508 due to the significant impact of the document 110. In general, decision process 508 may be determined for particular documents 110 based on one or more of approval status 120, directive 122, tier 126, aging 124, applicability 128 and other factors, such as time, to increase the reliability of documents 110 in repository 102.

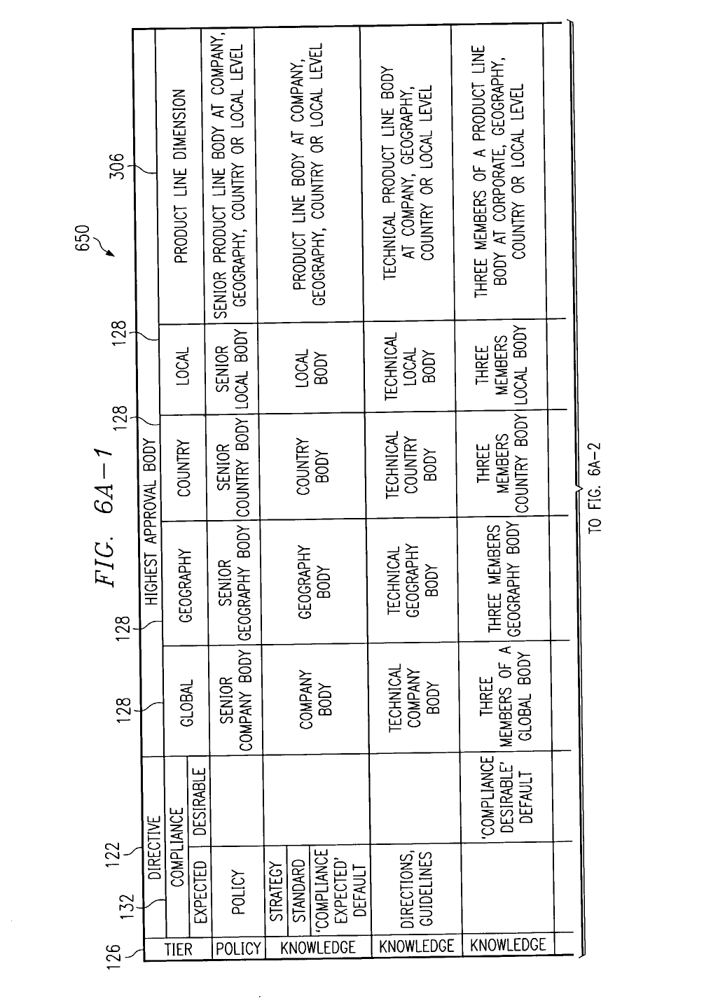

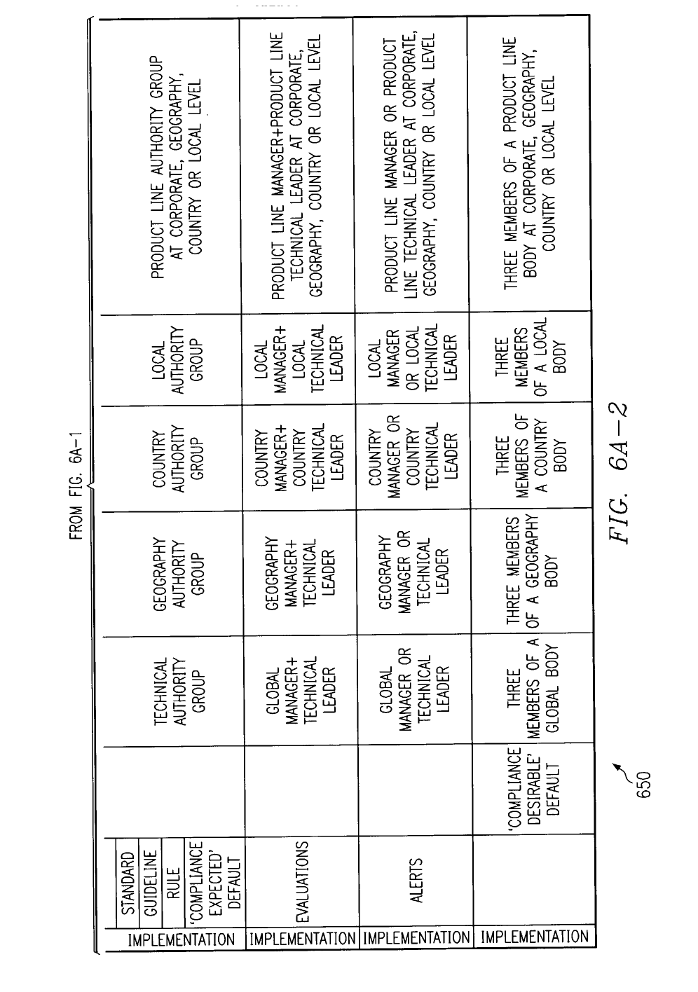

FIG. 6 is a flowchart illustrating a method for receiving feedback and approving documents 110 according to one embodiment of the present invention. The method begins at step 600 where a document 110 is submitted for approval. More specifically, based on tier 126, section 121, applicability 128 and other suitable criteria, administrator 111 may select an approval workflow for approval of document 110. In one embodiment, the approval workflows are predetermined for various documents 110. FIGS. 6A-1 and 6A-2 are a table 650 illustrating an example of how to select an approval workflow for a document 110 based on tier 128, compliance 132, directive 122, applicability 128 and dimension 306. Administrator 111 may use table 650 to select a particular approval workflow for document 110. The approval workflow indicates various members and/or groups of organization 103, and the highest approval body illustrated in FIG. 6A may delegate all or portions of document 110 to for approval. The highest approval body may choose to not delegate any or all portions of document 110 and approve document 110 themselves. For example, the approval workflow may comprise a list of bodies organized by geography and product line responsible for approving particular types of documents, such as that shown in Table 2. In one embodiment, community 502 for a particular document comprises the bodies of the approval workflow. In general, the approval workflow may vary based on particular details associated with organization 103 and may have a suitable form.

TABLE 2
Global Strategy Verification and Approval Workflow Table

| | | Action | | Directive Verification & Approval | | | |
|---|---|---|---|---|---|---|---|
| | Dead- | is at | | Techni- | Leader- | | Review |
| Level | lines | Level | Bodies | cal | ship | Status | Comments |
| 1. | | | Senior Company Body | | | Wait | |
| Senior Company | | | | | | | |
| Body | | | | | | | |
| 2. | | | Company Body | | Y | Wait | |
| Company Body | | | | | | | |
| 3. | | | Company Technical Body | Y | | Wait | |
| Company | | | | | | | |
| Technical Body | | | | | | | |
| 3. | | | US Leadership Body | | Y | Wait | |
| Geography | | | US Technical Body | Y | | Wait | |
| Oversight | | | European Leadership Body | | Y | Wait | |
| Bodies | | | European Technical Body | Y | | Wait | |
| | | | Asian Leadership Body | | Y | Wait | |
| | | | Asian Technical Body | Y | | Wait | |
| 4. | dd- | >here< | Applications Body US | | | | |
| Subject | mm- | | Applications Body Europe | | | | |
| Matter | yy | | Applications Body Asia | | | | |
| Expert | | | Infrastructure Body US | Y | | Pending Approval | |
| Oversight | | | Infrastructure Body Europe | Y | | Pending Approval | |
| Bodies | | | Infrastructure Bod Asia | Y | | Pending Approval | |
| (Optional) | | | Security Body US | Y | | Pending Approval | |
| | | | Security Body Europe | Y | | Approved with | Requirement 1, |
| | | | | | | requirements | Requirement 2 |
| | | | Security Body Asia | Y | | Approved | |
| 5. | | | US Forum UNIX | | | | |
| Subject | | | US Forum Mainframe | | | | |
| Matter | | | US Forum Databases | | | | |
| Expert | | | US Forum Programming | | | | |
| Bodies | | | Languages | | | | |
| | | | etc. | | | | |
| | | | Europe Forum UNIX | Y | | | |
| | | | Europe Forum Mainframe | | | | |
| | | | Europe Forum Databases | Y | | | |
| | | | Europe Forum Programming | | | | |
| | | | Languages | | | | |
| | | | Asia Forum UNIX | | | | |
| | | | Asia Forum Mainframe | | | | |
| | | | Asia Forum Databases | | | | |
| | | | Asia Forum Programming | | | | |
| | | | Languages | | | | |

Returning to FIG. 6, next, at step 602, administrator 111 notifies appropriate groups in the approval workflow for approval of document 110. Next, at decisional step 604, the groups responsible for approval determine whether to delegate all or portions of document 110 for approval to lower-level groups or to review and approve document 110 themselves. If approval of all or portions of document 110 is to be delegated, then the YES branch of decisional step 604 leads to step 606. At step 606, the appropriate lower-level group is notified and is given responsibility for reviewing and approving all or portions of document 110. If approval is not to be delegated, then the NO branch of decisional step 604 leads to step 608.

At step 608, document 110 is reviewed and commented upon by the one or more groups notified in step 602 and/or delegated to in step 606. Proceeding to decisional step 610, owner 140 and/or administrator 111 determine whether revisions are needed to document 110 based on the reviews and comments of step 608. If minor revisions are needed to document 110, then the MINOR branch of decisional step 610 leads to step 612. At step 612, document 110 is updated based on the reviews and comments of step 608. If major revisions are needed to document 110, then the MAJOR branch of decisional step 610 leads to decisional step 614. At decisional step 614, owner 140 and/or administrator 111 determine whether document 110 is to be removed from repository 102 because of the significant number of changes to be made or lack of approval. If the document is to be removed, the YES branch of decisional step 614 leads to step 615 where administrator 111 or owner 140 removes document 110 from repository 110. If document 110 is not removed from repository 102, then the NO branch of decisional step 614 leads to step 616 where status 120 of document 110 is set to “draft”.

Returning to decisional step 610, if no revisions are needed to document 110, then the NO branch of decisional step 610, leads to decisional step 618. At decisional step 618, document 110 received final review and comments from the groups in the approval workflow and the final approval decision is made on document 110. If document 110 is not approved, then the NO branch of decisional step 618 leads to decisional step 614. If document 110 is approved, then the YES branch of decisional step 618 leads to step 620. At step 620, approval status 136 is set to “approved”. Proceeding to step 622, members of community 502 are notified of the approved document 110.

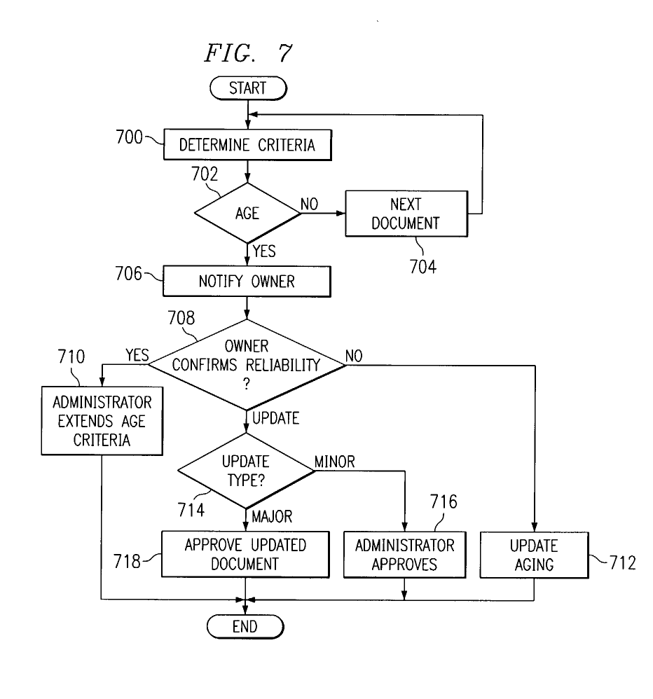

FIG. 7 is a flowchart illustrating a method for aging documents 110. The aging of documents 110 may be performed at suitable intervals, such as daily, weekly or monthly, based on organization 103. The method begins at step 700 where the aging criteria for aging of document 110 is determined. More specifically, different documents 110 may age at different rates and repository 102 may store individual criteria for aging document 110 in aging 124. Also, repository 102 may store aging criteria for groups of documents 110. For example, all documents 110 with a particular applicability 128 and particular tier 126 may share particular aging criteria.

In one embodiment, the default aging criteria for particular types of documents 110 is that after nine months a green status is downgraded to an amber status. After another three months, the amber status is downgraded to the red status. After a further three months, a use document flag portion of approval status 136 is set to do not use. In this embodiment, the approval body 200, as opposed to owner 140, may determine specific aging criteria. For example, evaluations may change from green to amber after three years, and from amber to red and “use document” set to do not use after four years.

Next, at decisional step 702, repository 102 determines whether document 110 should be aged. More specifically, based on the aging criteria for document 110, repository 102 determines whether owner 140 is to be notified that document 110 is becoming unreliable. For example, repository 102 may compare aging 124 to the aging criteria to determine whether document 110 is becoming unreliable. If document 110 is still reliable, then the NO branch of decisional step 702 leads to step 704. At step 704, the next document 110 to be aged is determined and the next document 110 is considered at step 700. If document 110 is to be aged, then the YES branch of decisional step 702 leads to step 706. At step 706, owner 140 is notified by repository 102 of the age of document 110. More specifically, owner 140 may be notified that document 110 should be reviewed as document 110 may be outdated. Owner 140 may also be notified that approval status 136 is to be updated to indicate that document 110 has become unreliable due to being outdated.

Next, at decisional step 708, owner 140 may confirm the reliability of document 110. If owner 140 confirms that document 110 is still reliable, then the YES branch of decisional step 708 leads to step 710 where administrator 111 extends aging 124 to indicate that document 110 is still reliable. For example, administrator 111 may change the aging criteria in aging 124 to indicate a longer reliability time. If owner 140 does not respond or does not confirm the reliability of document 110, then the NO branch of decisional step 708 leads to step 712. At step 712, status 120 is updated to indicate the unreliability of document 110. For example, a “green” aging status may be downgraded to an “amber” aging status, and an “amber” aging status may be downgraded to a “red” aging status. If owner 140 responds that the document is reliable if document 110 is updated, then the UPDATE branch of decisional step 708 leads to decisional step 714.

At decisional step 714, administrator 111 determines whether the updates suggested by owner 140 at decisional step 708 are minor or major. If the changes are minor, such as typographical, name or other non-substantive changes, then the MINOR branch of decisional step 714 leads to step 716 where administrator 111 approves the changes to document 110 and document 110 is updated. If the changes are major, then the MAJOR branch of decisional step 714 leads to step 718 where the updated document 110 is resubmitted for approval and approval status 136 is set to “draft”. In various embodiments, the definition of major and minor may vary based on particular details associated with organization 103 and other information.

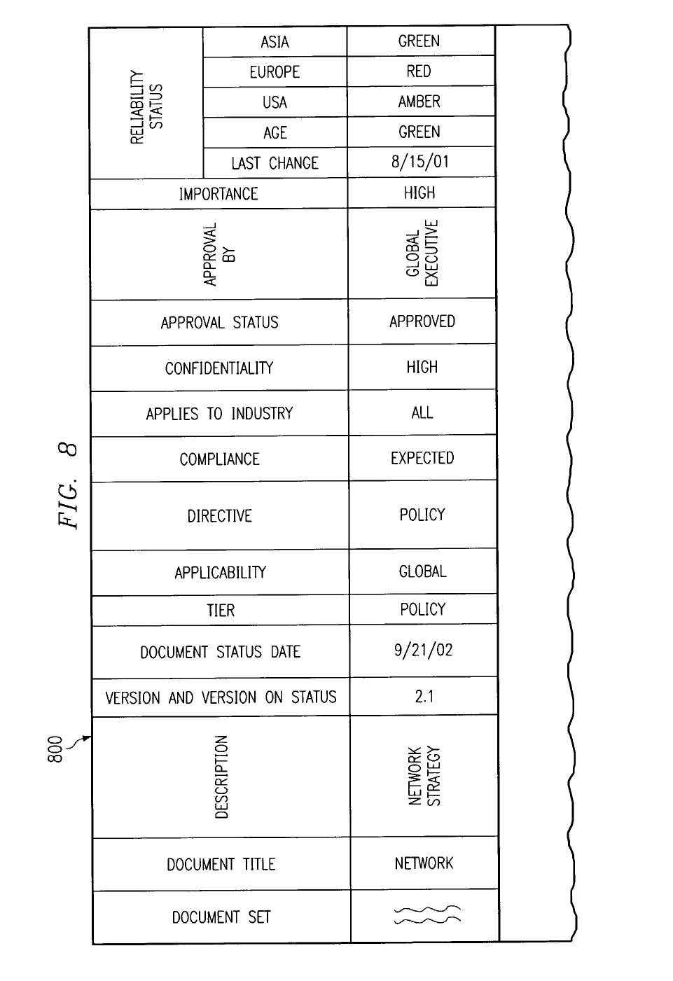

FIG. 8 is a table illustrating an example of information associated with a document 110 according to one embodiment of the present invention. Table 800 may comprise information displayed on a world wide web page associated with document 110 in repository 102. Table 800 includes one or more document set indications, a document title, a description of document 110, a version number and an indication of whether the version status is current, a document status date indicating when the version status updated, tier 126, directive 122, compliance level 132, an indication of one or more industries to which document 110 applies, a confidentiality indication, an approval status, who approval is performed by, an importance indication, an aging status indicator, and a reliability status indication for the United States, Europe and Asia geographic regions.

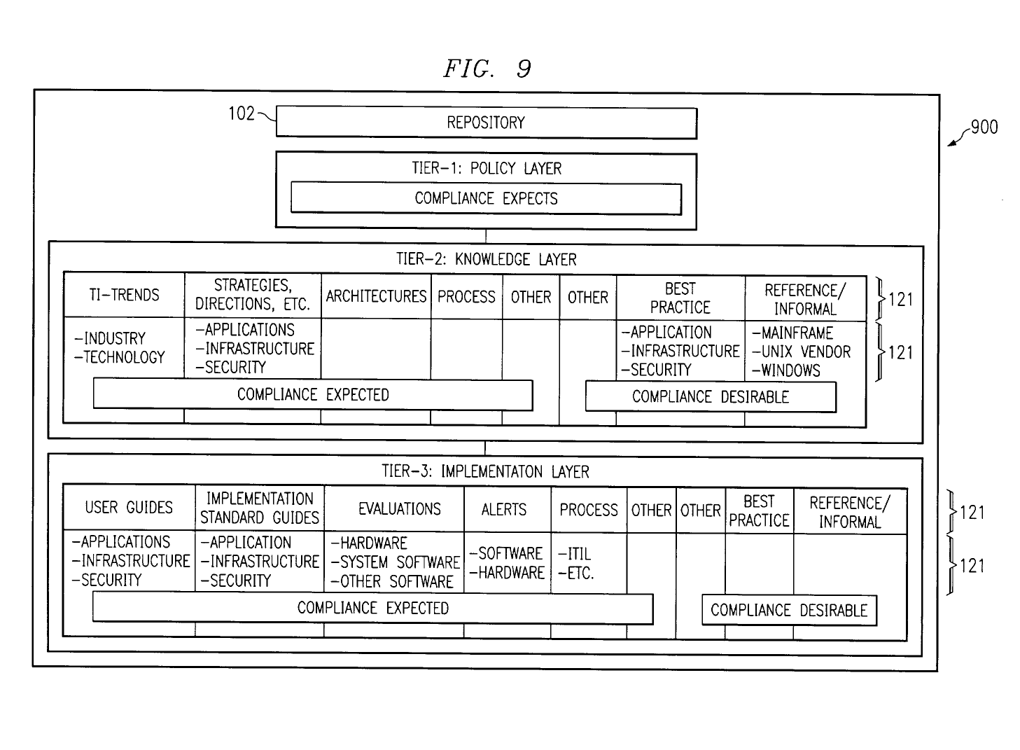

FIG. 9 is an illustration of one embodiment of a graphical user interface (GUI) 900 associated with repository 102. In one embodiment, users of repository 102 select elements from GUI 900. For example, selecting “Industry” under “IT Trends” of “Tier-2: Knowledge Layer” may automatically start a predetermined search routine for the selected information. For another example, a user might be interested in a strategy document with global applicability. The user may select “global”, “tier-2 section” and “Strategies Directions and Guidelines”. Based on the selection, a predetermined search routine is started to list all global Strategy, Direction and Guideline documents. Also, user may be presented with further sub-sections before the search routine is activated. Once one or more documents are found, the search may list based on the document sets associated with the found documents.

Although the present invention has been described with several embodiments, a number of changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for information management comprising:
storing a document in a central document repository;
determining a community associated with the document;
notifying the community of the document;
receiving feedback from the community based on the document;
generating an updated document based on the feedback;
approving the updated document based on an approval process;
determining an incentive technique to be associated with the document based on the document and the community; and
determining a decision process to be associated with the document.

2. The method for information management according to claim 1, wherein the incentive technique comprises a monetary incentive.

3. The method for information management according to claim 1, wherein determining the community comprises determining at least one group having knowledge related to the document.

4. The method for information management according to claim 3, wherein the group comprises a technical user group.

5. The method for information management according to claim 1, wherein notifying the community comprises communicating an electronic indication of the document and the location of the document within the central document repository.

6. The method for information management according to claim 1, wherein approving the updated document comprises:
determining the approval process for the document;
notifying at least one group associated with the approval process of the document; and
receiving approval of the document from the groups.

7. The method according to claim 1, wherein determining the decision process comprises selecting a balance between an authoritarian decision process and a democratic decision process.

8. The method according to claim 1 and further comprising associating at least one status indication with the updated document.

9. The method according to claim 8, wherein the status indication comprises an approval status indication and a user status indication.

10. The method according to claim 8 and further comprising generating a summary based on the status indications.

11. The method according to claim 10, wherein the status indications comprise an unreliable status indication and further comprising notifying an owner associated with the updated document based on the summary and the unreliable status indication associated with the updated document.

12. The method according to claim 1 and further comprising:
determining a template associated with the document; and
generating the document based on the template.

13. The method according to claim 1 and further comprising:
determining a compliance level associated with the document;
determining a directive associated with the document;
determining a section associated with the document;
determining a tier associated with the document; and
determining an applicability associated with the document.

14. A system for information management comprising:
means for storing a document in a central document repository;
means for determining a community associated with the document;
means for notifying the community of the document;
means for receiving feedback from the community based on the document;
means for generating an updated document based on the feedback;
means for approving the updated document based on an approval process;
means for determining an incentive technique to be associated with the document based on the document and the community; and
means for determining a decision process to be associated with the document.
